(19) United States
(12) Patent Application Publication
(10) Pub. No.: US 2026/0208632 A1
(43) Pub. Date: Jul. 23, 2026

(54) SELF-ALIGNING AND SELF-LOCKING FASTENER

(71) Applicant: GM GLOBAL TECHNOLOGY OPERATIONS LLC, DETROIT, MI (US)

(72) Inventor: Jason E. Burd, Ortonville, MI (US)

(21) Appl. No.: 19/027,505

(22) Filed: Jan. 17, 2025

(51) Int. Cl. B60N 2/02; F16H 25/24

(52) U.S. Cl. CPC B60N 2/0284; F16H 25/24; F16H 2025/2445

(57) ABSTRACT

A seat assembly of a vehicle includes a seat base including a seat pan and an extender bracket, and an actuator operably connecting the extender bracket to the seat pan. The actuator configured to urge movement of the extender bracket relative to the seat pan. The actuator includes a rotating spindle extending from the extender bracket toward the seat pan, and a spindle nut threaded onto the rotating spindle. The spindle nut is configured for axial and rotational retention in a seat pan opening of the seat pan. Rotation of the spindle urges movement of the extender bracket relative to the seat pan.

The subject disclosure relates to vehicles, and in particular to fastening systems of vehicle components.

Vehicles utilize various fastening systems to secure components into the vehicle. For example, seat assemblies of some vehicles include a seat base having an extender so a length of the seat base may be selectably varied. The extender is operated via an electromechanical actuator installed into the seat assembly. A spindle and corresponding nut secure the actuator and the extender to the seat base. Conventionally, installing the spindle and securing the nut is a difficult, time-consuming assembly. The art would welcome an improved assembly arrangement and method for completing installation of such components.

### SUMMARY

In one exemplary embodiment, a seat assembly of a vehicle includes a seat base including a seat pan and an extender bracket, and an actuator operably connecting the extender bracket to the seat pan. The actuator configured to urge movement of the extender bracket relative to the seat pan. The actuator includes a rotating spindle extending from the extender bracket toward the seat pan, and a spindle nut threaded onto the rotating spindle. The spindle nut is configured for axial and rotational retention in a seat pan opening of the seat pan. Rotation of the spindle urges movement of the extender bracket relative to the seat pan.

In addition to one or more of the features described herein the spindle nut includes a nut body having a nut body opening into which the spindle is threaded, and one or more snap fingers extending outwardly from the nut body for engagement with the seat pan opening to axially retain the spindle nut at the seat pan.

In addition to one or more of the features described herein the spindle nut includes a lock tab inserted into a collet of the seat pan opening to rotationally lock the spindle nut relative to the seat pan.

In addition to one or more of the features described herein two lock tabs are equally spaced around the spindle nut.

In addition to one or more of the features described herein the lock tab protrudes from an axial stop of the spindle nut.

In addition to one or more of the features described herein the axial stop is configured as a biasing element to urge the lock tab into engagement with the collet.

In addition to one or more of the features described herein the actuator includes a motor operably connected to the spindle to drive rotation of the spindle.

In addition to one or more of the features described herein a seat back extends from the seat base.

In another exemplary embodiment, a vehicle includes a vehicle body and a seat assembly positioned in the vehicle body. The seat assembly includes a seat base including a seat pan and an extender bracket, and an actuator operably connecting the extender bracket to the seat pan configured to urge movement of the extender bracket relative to the seat pan. The actuator includes a rotating spindle extending from the extender bracket toward the seat pan, and a spindle nut threaded onto the rotating spindle. The spindle nut is configured for axial and rotational retention in a seat pan opening of the seat pan. Rotation of the spindle urges movement of the extender bracket relative to the seat pan.

In addition to one or more of the features described herein the spindle nut includes a nut body having a nut body opening into which the spindle is threaded, and one or more snap fingers extending outwardly from the nut body for engagement with the seat pan opening to axially retain the spindle nut at the seat pan.

In addition to one or more of the features described herein the spindle nut includes a lock tab inserted into a collet of the seat pan opening to rotationally lock the spindle nut relative to the seat pan.

In addition to one or more of the features described herein two lock tabs are equally spaced around the spindle nut.

In addition to one or more of the features described herein the lock tab protrudes from an axial stop of the spindle nut.

In addition to one or more of the features described herein the axial stop is configured as a biasing element to urge the lock tab into engagement with the collet.

In addition to one or more of the features described herein the actuator includes a motor operably connected to the spindle to drive rotation of the spindle.

In addition to one or more of the features described herein a seat back extends from the seat base.

In yet another exemplary embodiment, a method of assembly of a seat base includes providing an actuator operably connected to an extender bracket configured for connection to a seat pan. The actuator includes a rotatable spindle. A spindle nut is threaded onto the spindle, and the spindle nut is inserted into a seat pan opening of the seat pan. The actuator is operated to engage a lock tab of the spindle nut with a collet of the seat pan opening to rotationally lock the spindle nut relative to the seat pan.

In addition to one or more of the features described herein the spindle nut is axially retained in the seat pan opening via one or more snap fingers extending from a nut body of the spindle nut engaged with the seat pan opening.

In addition to one or more of the features described herein operating the actuator includes rotating the spindle relative to the seat pan opening.

In addition to one or more of the features described herein a motor is operated to drive rotation of the spindle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an exemplary embodiment of a vehicle;

FIG. 2 is a schematic illustration of a seat assembly of a vehicle;

FIG. 3 is a partially disassembled view of an embodiment of an adjustable seat base of a vehicle;

FIG. 4 is an illustration of a spindle nut;

FIG. 5a is a first illustration of installation of a spindle nut into an opening;

FIG. 5b is a second illustration of installation of a spindle nut into an opening; and

FIG. 5c is a third illustration of installation of a spindle nut into an opening.

### DETAILED DESCRIPTION

The following description is merely exemplary in nature and is not intended to limit the present disclosure, its application or uses. It should be understood that throughout the drawings, corresponding reference numerals indicate like or corresponding parts and features.

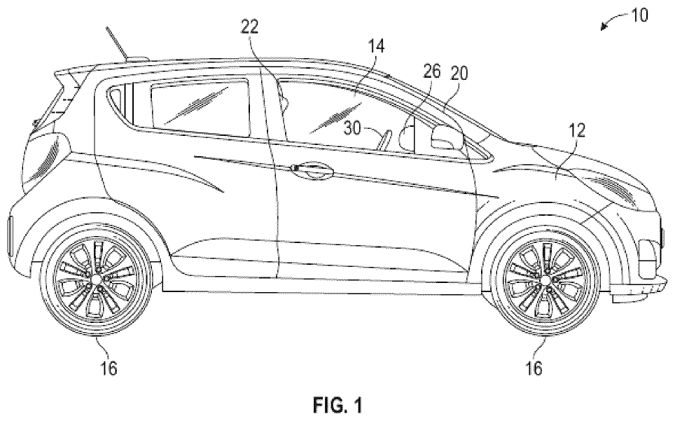

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, an occupant compartment 14 having seats 22 positioned behind a dashboard 26. A steering control 30 is arranged between seats 22 and dashboard 26. Steering control 30 is operated to control orientation of the steerable wheel(s) 16.

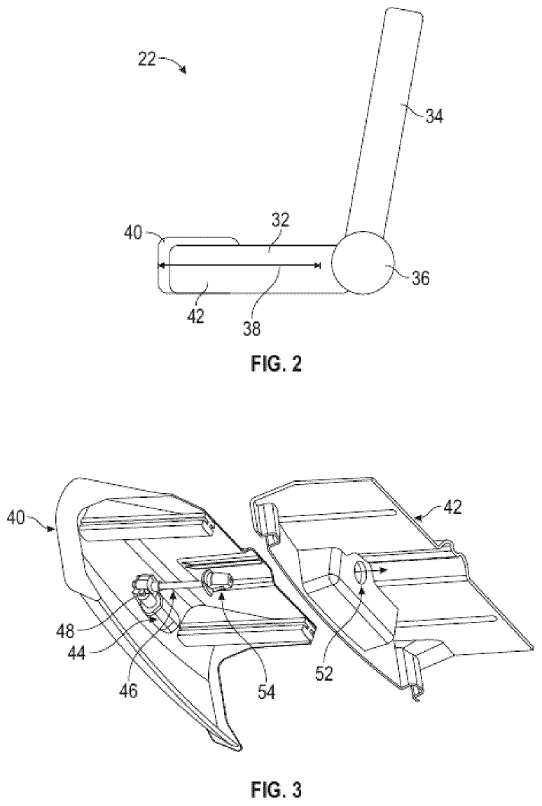

Referring now to FIG. 2, illustrated is an exemplary embodiment of a seat 22. The seat 22 includes a seat base 32 and a seat back 34 extending generally vertically upwardly from the seat base 32. The seat back 34 is positionally adjustable relative to the seat base 32 by, for example, rotating the seat back 34 about a seat pivot 36. The seat 22 further includes an adjustable seat base 32, in which an axial length 38 of the seat base 32 is adjustable for comfort of an occupant of the seat 22. To accomplish this, the seat 22 includes an extender bracket 40 assembled to a seat pan 42 of the seat base 32. Referring now to FIG. 3, a seat actuator 44 connects the extender bracket 40 to the seat pan 42, and operation of the seat actuator 44 moves the extender bracket 40 relative to the seat pan 42 thus adjusting the axial length 38 of the seat base 32.

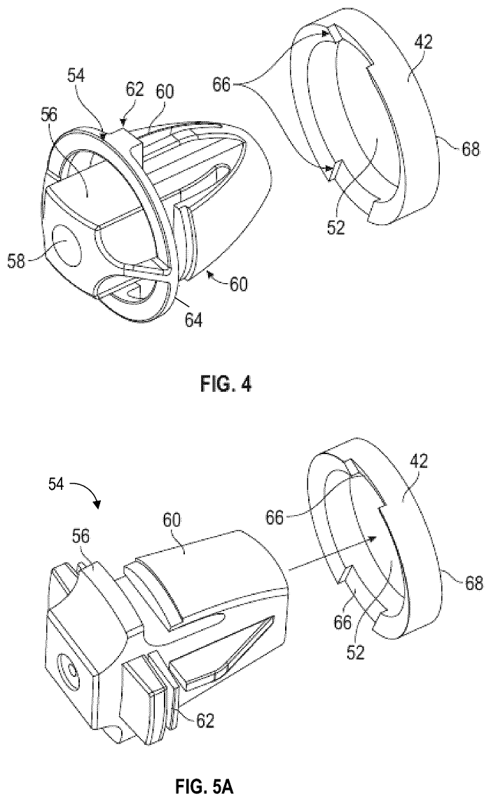

Referring to the partially disassembled view of FIG. 3, the seat actuator 44 is mounted to the extender bracket 40 and a spindle 46 extends from an actuator motor 48 of the seat actuator 44 toward the seat pan 42, where it connects to a seat pan opening 52 of the seat pan 42 via a spindle nut 54 secured to the spindle 46. As shown in FIG. 4, the spindle nut 54 includes a nut body 56 having a nut opening 58 into which the spindle 46 is installed. In an embodiment, the nut opening 58 is threaded and the spindle 46 is similarly threaded for installation into the nut opening 58. In some embodiments, the nut body 56 is tapered to act as a guide for installing the spindle nut 54 into the seat pan opening 52. Two snap fingers 60 protrude from the nut body 56 and are configured to retain the spindle nut 54 in the seat pan opening 52. This connection, while retaining the spindle nut 54 in the seat pan opening 52 does not rotationally lock the spindle nut 54 in the seat pan opening 52.

To accomplish the rotational lock, the spindle nut 54 includes one or more lock tabs 62. While two lock tabs 62 are illustrated in FIG. 4, one skilled in the art will readily appreciate that other quantities of lock tabs 62, such as one, three or more lock tabs 62 may be utilized in other configurations. Further, while in some embodiments the lock tabs 62 are identically shaped are equally-spaced around the spindle nut 54, in other embodiments the size, shape and/or spacing of the lock tabs 62 may vary. In the embodiment of FIG. 4, the lock tabs 62 protrude from an axial stop 64 of the spindle nut 54. The seat pan opening 52 includes a complimentary collet 66 receptive of a lock tab 62 such that when the lock tab 62 is installed in the collet 66, rotation of the spindle nut 54 relative to the seat pan opening 52 is prevented. In some embodiments, the axial stop 64 is further configured as a biasing member to axially urge the lock tab 62 into its respective collet 66. With the spindle nut 54 rotationally locked in the seat pan opening 52, when the seat actuator 44 is activated the spindle 46 rotates in the spindle nut 54 this urging axial movement of the extender bracket 40 relative to the seat pan 42.

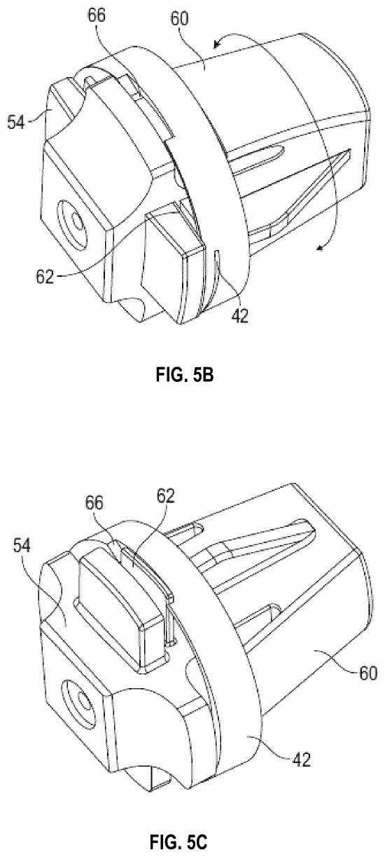

To install the extender bracket 40 to the seat pan 42, the seat actuator 44 is pre-installed to the extender bracket 40 with the spindle nut 54 installed onto the spindle 46, as shown in FIG. 3. Referring now to FIG. 5a, in which the axial stop 64 is omitted for clarity and simplicity of the drawing, the spindle nut 54 is snapped into the seat pan opening 52 and retained there via the snap fingers 60 of the spindle nut 54, which have an interference fit with a snap surface 68 of the seat pan 42. Referring to FIG. 5b, the seat actuator 44 (not shown) is operated rotating the spindle 46 together with the spindle nut 54 until the lock tab 62 of the spindle nut 54 moves into the collet 66, as illustrated in FIG. 5C, thus stopping rotation of the spindle nut 54 while still allowing rotation of the spindle 46.

This allows for installation of the extender bracket 40 to the seat pan 42 without pre-aligning the lock tab 62 with the collet 66, which improves ease of assembly of these components to the vehicle 10.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A seat assembly of a vehicle comprising:
a seat base including:
a seat pan; and
an extender bracket; and
an actuator operably connecting the extender bracket to the seat pan configured to urge movement of the extender bracket relative to the seat pan, the actuator including:
a rotating spindle extending from the extender bracket toward the seat pan; and
a spindle nut threaded onto the rotating spindle, the spindle nut configured for axial and rotational retention in a seat pan opening of the seat pan;
wherein rotation of the spindle urges movement of the extender bracket relative to the seat pan.

2. The seat assembly of claim 1, wherein the spindle nut includes:
a nut body having a nut body opening into which the spindle is threaded; and
one or more snap fingers extending outwardly from the nut body for engagement with the seat pan opening to axially retain the spindle nut at the seat pan.

3. The seat assembly of claim 2, wherein the spindle nut includes a lock tab inserted into a collet of the seat pan opening to rotationally lock the spindle nut relative to the seat pan.

4. The seat assembly of claim 3, further comprising two lock tabs equally spaced around the spindle nut.

5. The seat assembly of claim 3, wherein the lock tab protrudes from an axial stop of the spindle nut.

6. The seat assembly of claim 5, wherein the axial stop is configured as a biasing element to urge the lock tab into engagement with the collet.

7. The seat assembly of claim 1, wherein the actuator includes a motor operably connected to the spindle to drive rotation of the spindle.

8. The seat assembly of claim 1, further comprising a seat back extending from the seat base.

9. A vehicle, comprising:
a vehicle body; and
a seat assembly disposed in the vehicle body, the seat assembly including:
a seat base including:
a seat pan; and
an extender bracket; and
an actuator operably connecting the extender bracket to the seat pan configured to urge movement of the extender bracket relative to the seat pan, the actuator including:
a rotating spindle extending from the extender bracket toward the seat pan; and
a spindle nut threaded onto the rotating spindle, the spindle nut configured for axial and rotational retention in a seat pan opening of the seat pan;
wherein rotation of the spindle urges movement of the extender bracket relative to the seat pan.

10. The vehicle of claim 9, wherein the spindle nut includes:
a nut body having a nut body opening into which the spindle is threaded; and
one or more snap fingers extending outwardly from the nut body for engagement with the seat pan opening to axially retain the spindle nut at the seat pan.

11. The vehicle of claim 10, wherein the spindle nut includes a lock tab inserted into a collet of the seat pan opening to rotationally lock the spindle nut relative to the seat pan.

12. The vehicle of claim 11, further comprising two lock tabs equally spaced around the spindle nut.

13. The vehicle of claim 11, wherein the lock tab protrudes from an axial stop of the spindle nut.

14. The vehicle of claim 13, wherein the axial stop is configured as a biasing element to urge the lock tab into engagement with the collet.

15. The vehicle of claim 9, wherein the actuator includes a motor operably connected to the spindle to drive rotation of the spindle.

16. The vehicle of claim 9, further comprising a seat back extending from the seat base.

17. A method of assembly of a seat base comprising:
providing an actuator operably connected to an extender bracket configured for connection to a seat pan, the actuator including a rotatable spindle;
threading a spindle nut onto the spindle;
inserting the spindle nut into a seat pan opening of the seat pan; and
operating the actuator to engage a lock tab of the spindle nut with a collet of the seat pan opening to rotationally lock the spindle nut relative to the seat pan.

18. The method of claim 17, further comprising axially retaining the spindle nut in the seat pan opening via one or more snap fingers extending from a nut body of the spindle nut engaged with the seat pan opening.

19. The method of claim 17, wherein operating the actuator includes rotating the spindle relative to the seat pan opening.

20. The method of claim 19, further comprising operating a motor to drive rotation of the spindle.
